(19) United States
(12) Patent Application Publication
(10) Pub. No.: US 2017/0356438 A1
(43) Pub. Date: Dec. 14, 2017

(54) PORTABLE FLUID PUMP SYSTEM

(71) Applicant: Actuant Corporation, Menomonee Falls, WI (US)

(72) Inventor: Nathan Adam Hughes, Cottage Grove, WI (US)

(21) Appl. No.: 15/551,072

(22) PCT Filed: Feb. 16, 2016
(86) PCT No.: PCT/US2016/018021

§ 371 Date: Aug. 15, 2017

Related U.S. Application Data
(60) Provisional application No. 62/117,113, filed on Feb. 17, 2015.

(51) Int. Cl. F04B 53/08; F04B 23/02; F15B 21/04; F15B 1/26

(52) U.S. Cl. CPC F04B 53/08; F15B 1/26; F04B 23/028; F15B 21/042

(57) ABSTRACT

A fluid pump system includes a housing, a motor, a fan, and a fluid conduit. The housing includes a wall having a first end and a second end, and the housing defining a first axis extending between the first end and the second end. The wall extends at least partially around the first axis and at least partially encloses a chamber. The motor is at least partially positioned within the chamber. The fan is positioned proximate the first end, and the fan generates air flow through the chamber. The fluid conduit is configured to be in fluid communication with a fluid reservoir, and at least a portion of the fluid conduit is positioned within the chamber.

### CROSS-REFERENCE TO RELATED APPLICATION

This application claims the benefit of prior-filed, co-pending U.S. Provisional Application Ser. No. 62/117,113, filed Feb. 17, 2015, the entire contents of which are incorporated by reference herein.

### FIELD

The present invention relates to fluid pumps and, more particularly, to a cooling assembly for a fluid pump.

### SUMMARY

Hydraulic pumps supply pressurized hydraulic fluid to actuators or work-producing devices to perform a variety of mechanical operations, including lifting, pressing, punching, etc. A fluid pump system may include a reservoir, a pump for moving fluid from the reservoir, and a motor for driving the pump. The system may include a conduit for conveying the fluid to an actuator and back to the reservoir, and a mechanism for cooling the fluid.

In one independent aspect, a fluid pump system includes a housing, a motor, a fan, and a fluid conduit. The housing includes a wall having a first end and a second end, and the housing defining a first axis extending between the first end and the second end. The wall extends at least partially around the first axis and at least partially encloses a chamber. The motor is at least partially positioned within the chamber. The fan is positioned proximate the first end, and the fan generates air flow through the chamber. The fluid conduit is configured to be in fluid communication with a fluid reservoir, and at least a portion of the fluid conduit is positioned within the chamber.

In another independent aspect, a fluid pump system includes a motor, a housing, a fan, and a fluid conduit. The motor has a shaft defining a shaft axis. The housing has a first end, a second end, and a wall. The wall extends around at least a portion of the motor, and the housing defines a chamber between the first end, the second end, and the wall. The fan is positioned proximate the first end of the housing, and the fan generates air flow around the motor and through the chamber in a direction substantially parallel to the shaft axis. The fluid conduit is configured to be in fluid communication with a fluid reservoir, and at least a portion of the fluid conduit is positioned within the chamber.

In yet another independent aspect, a cooling assembly for a fluid pump system includes a housing and a fan. The housing includes a first end and a second end, and a central axis extending between the first end and the second end. The housing further includes an outer wall extending between the first end and the second end and extending at least partially around the central axis. A space at least partially enclosed by the outer wall defines a chamber. The fan is positioned adjacent the first end of the housing, and a fan positioned adjacent the first end of the housing. The fan generates air flow through the chamber to cool the motor and to cool the fluid in the fluid conduit. The air flow passes through the chamber in a direction substantially parallel to the central axis.

Other independent aspects of the invention will become apparent by consideration of the detailed description, claims and accompanying drawings.

### BRIEF DESCRIPTION OF THE DRAWINGS

FIG. 1 is a perspective view of a portable fluid pump system and a frame.

FIG. 2 is a perspective view of the portable fluid pump system of FIG. 1.

FIG. 3 is a partially exploded perspective view of the system of FIG. 2.

FIG. 4 is a perspective view of a motor and cooling assembly of the system of FIG. 2.

FIG. 5 is an exploded view of the assembly of FIG. 4.

FIG. 6 is a section view of the assembly of FIG. 4 viewed generally along line 6-6.

FIG. 7 is a perspective view of a shroud.

FIG. 8 is a top view of the shroud of FIG. 6.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

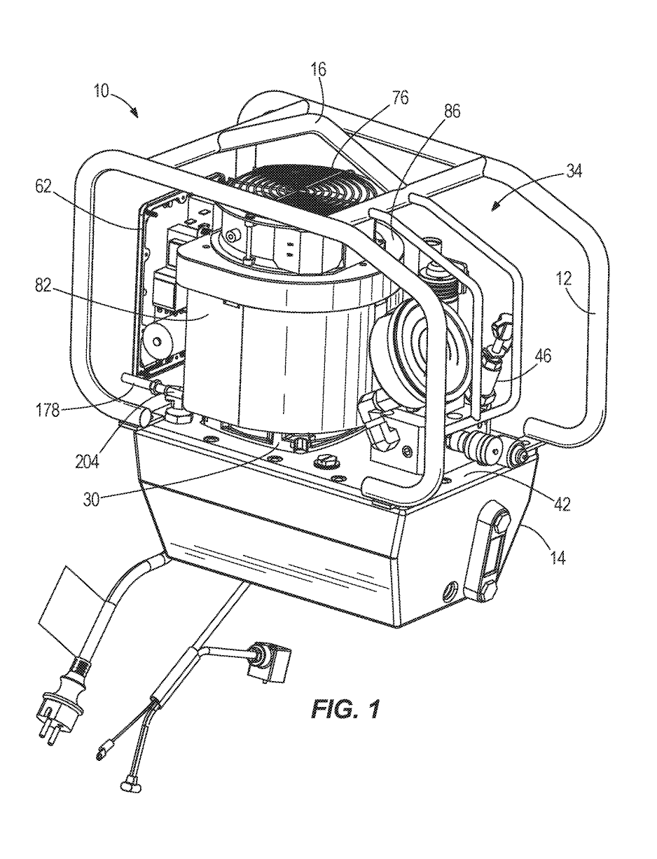

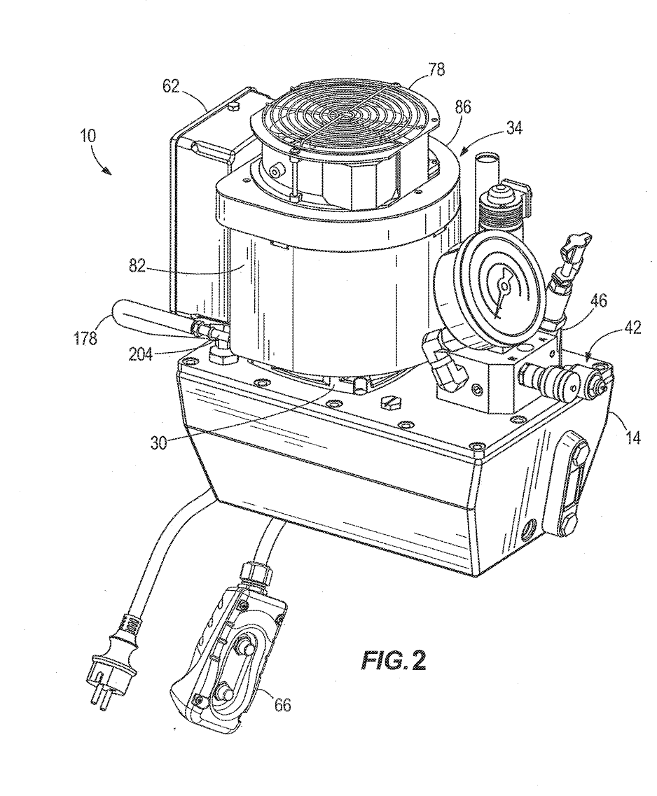

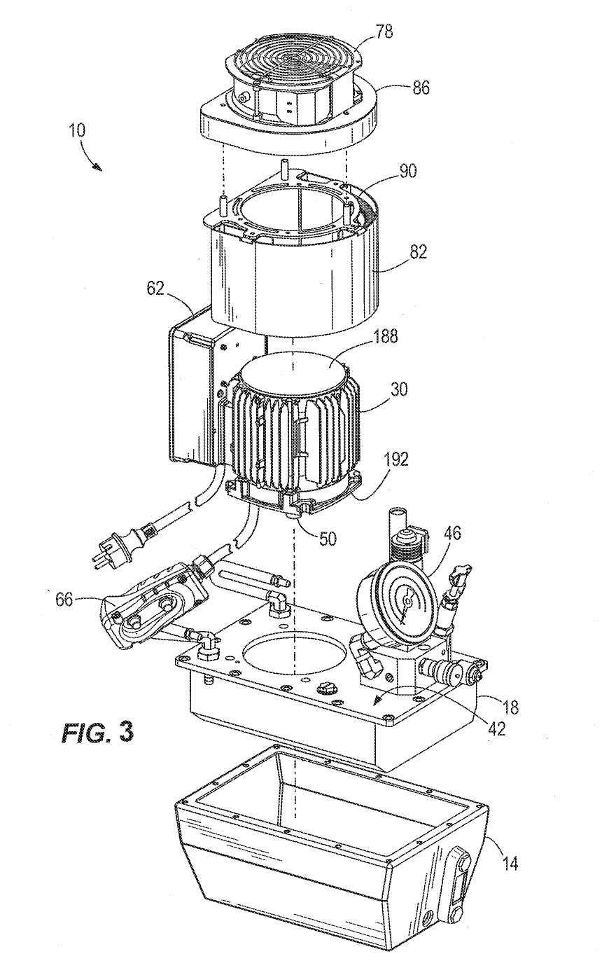

FIGS. 1-3 illustrate a portable fluid pump system 10. As illustrated in FIG. 1, the pump system 10 is supported in a frame or roll cage 12 including a handle 16 for carrying the pump system 10. Further, in some constructions, the pump system 10 is supported for movement on a mobile cart or carriage (not shown). The roll cage 12 and the handle 16 are removed from the portable fluid pump system 10 in FIG. 2 for easier viewing of the other components. The pump system 10 of FIGS. 1 and 2 includes a reservoir 14, a pump 18 (FIG. 3), a motor 30 and a cooling assembly 34. In one construction, the pump 18 is a high-pressure three-stage pump and has a bypass valve or unloading valve (not shown) for diverting excess fluid flow toward the reservoir 14 when the pump 18 is operating under a predetermined condition (described in further detail below). Further, the fluid reservoir 14 has a top surface 42 generally arranged in a plane, and the motor 30 and the cooling assembly 34 are positioned on the top surface 42. The pump system 10 further includes a valve and gauge assembly 46 positioned adjacent the cooling assembly 34.

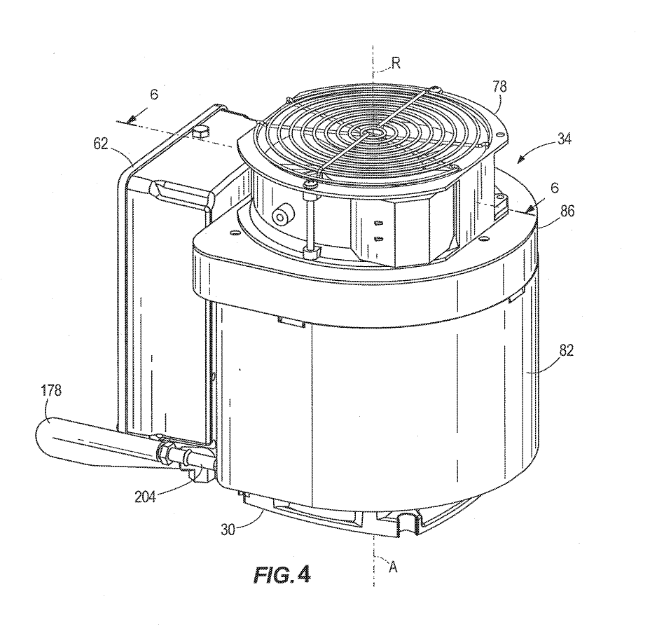

Referring now to FIGS. 3-4, the motor 30 includes a motor shaft 50 defining a shaft axis A (FIG. 4). In the illustrated construction, the motor shaft 50 extends vertically downwardly through the top surface 42 of the reservoir 14 to drive the pump 18, and the shaft axis A is substantially perpendicular to the top surface 42 of the fluid reservoir 14. In other constructions, the shaft axis A may extend in a horizontal direction or a direction parallel to the top surface 42 of the reservoir 14, or may extend in a direction at an oblique angle relative to the top surface 42 of the reservoir 14. The pump system 10 also includes an electrical control module or box 62 coupled to the motor 30. The electrical control box 62 includes a power cord (FIG. 2) for receiving electrical power from a source (e.g., an electrical outlet). The electrical control box 62 is also coupled to an interface (e.g., a pendant 66 (FIG. 2)) for receiving an input from an operator.

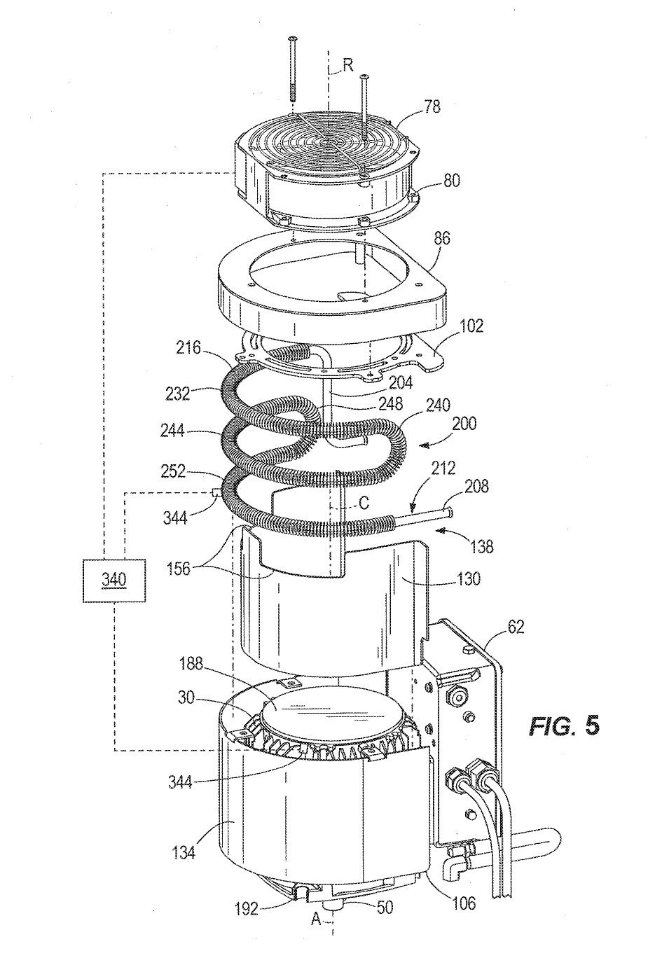

As shown in FIGS. 4-5, the cooling assembly 34 includes a fan 78, a housing or shroud 82, and a heat exchanger conduit 200. The fan 78 rotates about an axis of rotation R (FIG. 4) in a plane that is substantially perpendicular axis R. In the illustrated construction, the fan 78 is positioned axially above the motor 30 and the axis of rotation R is coaxial with the shaft axis A, while, in other constructions (not shown), the axis of rotation of the fan 78 may be offset from the shaft axis A. The fan 78 is coupled to an air directing section or fan support 86 positioned between the fan 78 and the shroud 82. The fan support 86 is coupled to a cover 90 (FIG. 3) and the shroud 82 by fasteners.

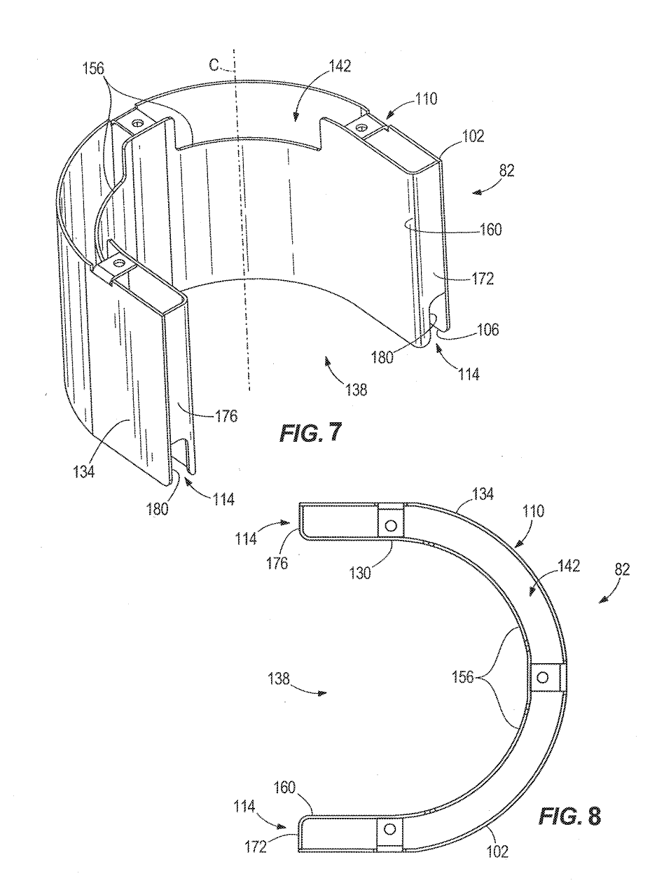

Referring to FIG. 5, the shroud 82 extends at least partially around the motor 30. The shroud 82 is positioned above the top surface 42 of the reservoir 14 (FIG. 2). As shown in FIG. 7, the shroud 82 includes a first end 102 proximate the fan 78 and a second end 106 proximate the top surface 42 of the reservoir 14. In the illustrated construction, the shroud 82 includes an arcuate portion 110 and a pair of parallel straight portions 114. The arcuate portion 110 extends around a central axis C. In the illustrated construction, the central axis C is coaxial with the shaft axis A and the axis of rotation R of the fan 78. In other constructions (not shown), the shroud 82 may have a different shape, and/or the shroud 82 may define an axis C that is offset from the shaft axis A and/or the axis of rotation R of the fan 78.

Referring to FIGS. 7-8, in the illustrated embodiment, the shroud 82 includes an inner wall 130 (FIG. 8) and an outer wall 134, each of which extend between the first end 102 and the second end 106 of the shroud 82. The outer wall 134 is spaced apart from the inner wall 130 in a radially-outward direction relative to the central axis C of the shroud 82. The shroud 82 defines a chamber that encloses the motor 30 and the conduit 200. A first cavity 138 is defined by a space partially enclosed by the inner wall 130, and a second cavity 142 is defined by a space between the inner wall 130 and the outer wall 134 and between the first end 102 and the second end 106. The inner wall 130 defines openings or cutouts 156 arranged adjacent the first end 102 of the shroud 82. The cutouts 156 extend along a portion of the inner wall 130 on the arcuate portion 110 and permit air flow between the first cavity 138 and the second cavity 142. The shroud 82, as best shown in FIG. 8, is generally U-shaped and defines a large space or opening 160 between the first end 102 and the second end 106 and between the straight portions 114.

In the illustrated construction, the inner wall 130 includes a first side wall 172 and a second side wall 176 extending parallel to the central axis C of the shroud 82. The side walls 172, 176 are formed integrally with the inner wall 130 and abut the outer wall 134 to enclose the sides of the second cavity 142. Each side wall 172, 176 includes a conduit opening 180. In one construction, the conduit openings 180 are arranged adjacent the second end 106 of the shroud 82. The outer wall 134 includes tabs positioned adjacent the first end 102 of the shroud 82. The tabs include holes receiving fasteners to couple the fan support 86 and the cover 90 to the first end 102 of the shroud 82.

Referring again to FIGS. 4-6, the motor 30 is at least partially positioned within the first cavity 138 of the shroud 82 and is coupled to the reservoir 14 by fasteners (not shown). When the motor 30 is partially positioned within the shroud 82, one side of the motor 30 is exposed via the large opening 160. The electrical control box 62 is coupled to the exposed side of the motor 30 and positioned between the side walls 172, 176 of the shroud 82. The electrical control box 62 is laterally offset from the shaft axis A and the central axis C of the shroud 82.

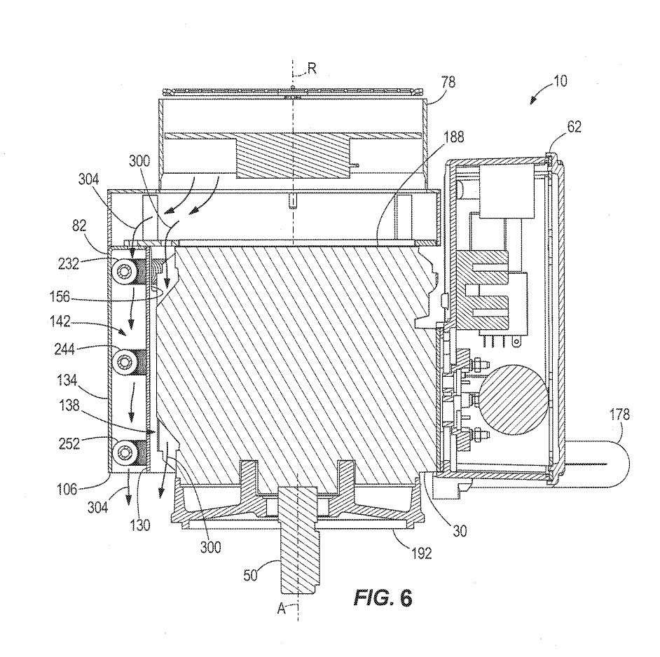

As shown in FIG. 6, the outer wall 134 of the shroud extends radially outwardly from a periphery 80 of the fan 78. In the illustrated construction, the fan 78 is driven by a fan motor built into the fan 78. In other constructions, the fan motor may be separate from the fan 78. The fan motor may be electrically or hydraulically operated.

Referring again to FIG. 5, in some constructions, the cooling assembly 34 may include temperature sensors 344 and a controller 340 in communication with the sensors 344 such that the controller 340 is configured to receive signals from the temperature sensors 344. In the illustrated construction, one of the temperature sensors 344 senses a temperature of the motor 30, and another sensor 344 senses a temperature of the fluid conduit 200. In other constructions, the cooling assembly 34 may include fewer or more sensors 344, and/or the sensors 344 may be configured to measure the temperatures of other components and/or other parameters of the pump system 10. The controller 340 may further be configured to control operation of the fan 78 and/or the fan motor based on the signals received from the one or more temperature sensors 344.

Referring to FIGS. 5-6, the fluid conduit 200 is at least partially positioned within the second cavity 142. A fluid bypass line 178 of the portable pump 18 fluidly couples the fluid reservoir 14 to the fluid conduit 200 of the cooling assembly 34, and the fluid conduit 200 is in fluid communication with the fluid reservoir 14. The fluid conduit 200 extends between the side walls 172, 176. An upstream section 204 of the fluid conduit 200 (i.e., proximate the fluid bypass line 178) passes through the conduit opening 180 of the first side wall 172, while a downstream section 208 of the fluid conduit 200 passes through the conduit opening 180 of the second side wall 176.

The fluid conduit 200, as best shown in FIG. 5, includes a plurality of fins 216 connected to an outer surface, for example, to improve heat transfer characteristics of the fluid conduit 200. In the illustrated construction, the fluid conduit 200 is formed as multiple sections extending through the arcuate portion of the second cavity 142. An upstream section 204 of the fluid conduit 200 is connected to the fluid bypass line 178 and extends towards the first end 102 of the shroud 82.

A first section 232 is arranged proximate the first end 102 of the shroud 82 and extends in an arcuate manner in a plane substantially perpendicular to the central axis C of the shroud 82. The fluid conduit 200 continues downwardly through a first curved portion 240 of the fluid conduit 200 to a second or intermediate section 244 of the fluid conduit 200. The second section 244 is arranged farther from the first end 102 of the shroud 82 than the first section 232 and is spaced apart from the first section 232 in a direction parallel to the central axis C. The second section 244 conveys fluid in an opposite direction relative to the first section 232. The second section 244 extends in an arcuate manner in a plane substantially perpendicular to the central axis C of the shroud 82, similar to the first section 232.

A second curved portion 248 of the fluid conduit 200 extends downwardly from the second section 244 and connects to a third or lower section 252 of the fluid conduit 200. The third section 252 is configured to direct fluid in substantially the same direction as the first section 232 and in substantially the opposite direction of the second section 244. Similar to the first section 232 and the second section 244, the third section 252 extends in an arcuate manner and in a plane substantially perpendicular to the central axis C of the shroud 82. The third section 252 is arranged farther from the first end 102 of the shroud 82 than the first section 232 and the second section 244 and is spaced apart from the first section 232 and the second section 244 in a direction parallel to the central axis C. Further, the third section 252 directs fluid to the downstream section 208 of the fluid conduit 200 and then into the reservoir 14. In the illustrated construction, the first section 232, the second section 244, and the third section 252 are substantially parallel to one another, to the plane formed by the top surface 42 of the fluid reservoir 14, and to the plane of the fan 78.

In other constructions (not shown), the fluid conduit 200 may include fewer or more sections within the second cavity 142. Additionally, the fluid conduit sections 232, 244, 252 may be arranged in a different manner within the second cavity 142. For example, in some constructions, the sections 232, 244, 252 of the fluid conduits may be arranged at an angle relative to a plane substantially perpendicular to the central axis C of the shroud 82, parallel the central axis C of the shroud 82, etc.

In another construction, the shroud 82 may be formed without the inner wall such that the shroud 82 only includes the outer wall 134. In this construction, the fluid conduit 200 and the motor 30 are not separated but instead are positioned within the same cavity.

In another construction (not shown), the first section 232 may be arranged within the second cavity 142 at a radial location closer to the central axis C of the shroud 82 than the second section 244 or vice versa. Similarly, the second section 244 may be arranged within the second cavity 142 at a radial location closer to the central axis C than the third section 252 or vice versa. As a result, the first, second, and third sections 232, 244, 252 of the fluid conduit 200 may be radially offset from each other relative to the central axis C.

In operation, the portable fluid pump system 10 may be manually controlled using the control pendant 66. The electrical control box 62 receives power from the cord and controls the motor 30. The motor 30 is operated to drive the pump 18 and supply hydraulic fluid to an external device (not shown). In the illustrated construction, the pump 18 is a multistage pump and includes a bypass valve. When the pump 18 in the final (output) stage reaches a predetermined output pressure, excess flow from the first stage is diverted toward the reservoir 14. In some constructions, the output pressure of the pump 18 is 10,000 psi (10 ksi). The excess flow is routed to the fluid conduit 200 in the second cavity 142 to be cooled before being conveyed to the reservoir 14.

In other constructions, the pump 18 is a one stage pump, a two stage pump, or another type of multistage pump. In other constructions, the pump 18 may not include a bypass valve. In still other constructions, unpressurized reservoir return fluid is directed through the fluid conduit 200 to cool the fluid. Other constructions could include constant horsepower (infinite stage) pumps, or closed loop system pumps.

The fan motor drives the fan 78 to generate air flow between the first end 102 and the second end 106 of the shroud 82 to cool the motor 30 and the fluid in the fluid conduit 200. In the illustrated embodiment, the cooling medium is air.

In one embodiment, shown in FIG. 6, the air flow is separated by the shroud 82 into a first air flow path 300 and a second air flow path 304. The air flow from the fan 78 in the first air flow path 300 passes through the first cavity 138 and around the motor 30. The air flow from the fan 78 in the second air flow path 304 flows into the second cavity 142 and passes over the fluid conduit 200. A portion of the air flow from the first flow path 300 may also pass through openings in the cover 90 and the cutouts 156 in the inner wall 130 and into the second cavity 142. The air flow from each path 300, 304 may exit the cooling assembly 34 by passing through a space between the second end 106 and the top surface 42 of the reservoir 14. In other embodiments, the fan 78 may be operated to pull air upwardly from the second end 106 of the shroud 82 toward the first end 102.

After the motor 30 is turned off and the portable fluid pump 18 stops running, the fan motor can continue to run the fan 78. This allows air to continue to flow through the first and second cavities 138, 142, allowing the motor 30 and the fluid conduit 200 to be further cooled after operation of the pump 18 has ceased.

In some conditions (e.g., low temperature environments), the fan 78 may not be operated while the motor 30 is running. This allows for the hydraulic fluid to become heated and to reach an ideal operating temperature faster than if the fan 78 were in operation. In constructions in which the cooling assembly 34 includes the controller 340 for receiving signals from the sensors 344, the controller 340 may adjust operation of the fan 78 according to signals generated by the sensors 344. For example, the controller 340 may decrease the speed of the fan motor to decrease the speed of the fan 78 if a signal from a sensor 344 indicates that the temperatures in the motor 30 and/or the fluid conduit 200 are lower than desired, or the controller 340 may increase the speed of the fan motor to increase the speed of the fan 78 if a signal from a temperature sensor 344 indicates that the temperatures in the motor 30 and/or the fluid conduit 200 are higher than desired.

The above-described cooling assembly 34 allows for a single fan 78 to cool both the motor 30 of and the fluid conduit 200 of the portable fluid pump 18. The system 10 may have a reduced size, weight, fewer components, etc. compared to conventional portable fluid pump systems. The motor 30 is also spaced apart from the fan 78, so the fan 78 is not coupled to the motor shaft 50. This arrangement may reduce contaminants in the motor 30, improve the lifespan of components (e.g., the bearings) of the motor 30, etc.

Thus, a portable fluid pump may include a single fan to cool a motor and fluid. A housing or shroud may include a chamber for the motor and a fluid conduit, and air flow from a fan may be directed into the chamber.

Although aspects have been described in detail with reference to certain preferred embodiments, variations and modifications exist within the scope and spirit of one or more independent aspects as described. One or more independent features or independent advantages may be set forth in the claims.

What is claimed is:

1. A fluid pump system comprising:
a housing including a wall having a first end and a second end, the housing defining a first axis extending between the first end and the second end, the wall extending at least partially around the first axis, the wall at least partially enclosing a chamber;
a motor at least partially positioned within the chamber;
a fan positioned proximate the first end, the fan generating air flow through the chamber; and
a fluid conduit configured to be in fluid communication with a fluid reservoir, at least a portion of the fluid conduit positioned within the chamber.

2. The system of claim 1, wherein the motor is a first motor, and the fluid pump system further comprising a second motor for operating the fan.

3. The system of claim 1, wherein the wall is an outer wall, the housing further including an inner wall extending at least partially around the first axis, the inner wall spaced apart from the outer wall in a radially inward direction such that the inner wall is positioned closer to the first axis than the outer wall, wherein a first cavity is positioned radially within the inner wall and adjacent the first axis, wherein a second cavity is defined between the inner wall and the outer wall.

4. The system of claim 3, wherein the inner wall defines at least one cutout to provide fluid communication between the first cavity and the second cavity.

5. The system of claim 3, wherein the fluid conduit is positioned within the second cavity.

6. The system of claim 1, wherein the wall defines a first edge and a second edge spaced apart from the first edge by a gap, the fluid pump system further comprising an electrical box positioned at least partially in the gap and coupled to the motor.

7. The system of claim 6, wherein the fluid conduit includes an inlet portion and an outlet portion, the inlet portion positioned proximate the first edge and the outlet portion positioned proximate the second edge.

8. The system of claim 1, wherein the fluid conduit includes an outer surface and a plurality of fins connected to the outer surface.

9. The system of claim 1, wherein the fluid conduit includes a first section and a second section positioned within the chamber, the first section oriented parallel to the second section.

10. The system of claim 9, wherein the first section extends in an arcuate manner and is oriented in a first plane perpendicular to the first axis, wherein the second section extends in an arcuate manner in a second plane perpendicular to the first axis and spaced apart from the first plane.

11. The system of claim 1, further comprising,
a sensor configured to sense a temperature of at least one of the fluid conduit and the motor, the sensor further configured to generate a signal indicative of the temperature of the at least one of the fluid conduit and the motor; and
a controller configured to receive the signal from the sensor and configured to adjust the operation of the fan in response to the signal.

12. A fluid pump system comprising:
a motor having a shaft defining a shaft axis;
a housing having a first end, a second end, and a wall, the wall extending around at least a portion of the motor, the housing defining a chamber between the first end, the second end, and the wall;
a fan positioned proximate the first end of the housing, the fan generating air flow around the motor and through the chamber in a direction substantially parallel to the shaft axis; and
a fluid conduit configured to be in fluid communication with a fluid reservoir, at least a portion of the fluid conduit positioned within the chamber.

13. The system of claim 12, wherein the motor is a first motor, the portable fluid pump assembly further comprising a second motor for operating the fan.

14. The system of claim 12, wherein the wall is an outer wall, the housing further including an inner wall extending at least partially around the motor and positioned between the outer wall and the motor, wherein a first cavity is at least partially enclosed within the inner wall and the motor is positioned in the first cavity, wherein a second cavity is defined between the inner wall and the outer wall.

15. The system of claim 14, wherein the fluid conduit is positioned within the second cavity.

16. The system of claim 12, wherein the fluid conduit includes a first section and a second section positioned within the chamber, the first section extending in an arcuate manner and oriented in a first plane perpendicular to the shaft axis, wherein the second section extends in an arcuate manner in a second plane perpendicular to the first axis and spaced apart from the first plane.

17. The system of claim 12, further comprising a sensor configured to sense a temperature of at least one of the fluid conduit and the motor, the sensor further configured to generate a signal indicative of the temperature in the at least one of the fluid conduit and the motor; and
a controller configured to receive the signal from the sensor and configured to adjust the operation of the fan in response to the signal.

18. A cooling assembly for a fluid pump system, the fluid pump system including a motor and a fluid conduit, the cooling assembly comprising:
a housing including a first end and a second end, a central axis extending between the first end and the second end, the housing further including an outer wall extending between the first end and the second end and extending at least partially around the central axis, a space at least partially enclosed by the outer wall defining a chamber; and
a fan positioned adjacent the first end of the housing, the fan generating air flow through the chamber to cool the motor and to cool the fluid in the fluid conduit, the air flow passing through the chamber in a direction substantially parallel to the central axis.

19. The cooling assembly of claim 18, wherein the fan lies in a plane perpendicular to the central axis.

20. The cooling assembly of claim 18, wherein the wall is an outer wall, the housing further including an inner wall extending at least partially around the central axis and positioned between the outer wall and the central axis, wherein a first cavity is at least partially enclosed within the inner wall adjacent the central axis, wherein a second cavity is defined between the inner wall and the outer wall.

21. The cooling assembly of claim 20, further comprising a fluid conduit positioned within the second cavity.

22. The cooling assembly of claim 18, wherein the outer wall extends a greater radial distance away from the central axis than an outer periphery of the fan.

23. The cooling assembly of claim 18, further comprising a sensor configured to sense a temperature of at least one of the motor and the fluid conduit, the sensor further configured to generate a signal indicative of the temperature of the one of the second motor and the fluid conduit; and
a controller configured to receive the signal from the sensor and configured to adjust the operation of the fan in response to the signal.
